(19) United States
(12) Patent Application Publication
(10) Pub. No.: US 2025/0382025 A1
(43) Pub. Date: Dec. 18, 2025

(54) AUTOMATICALLY ALIGNING, DEFLECTION AND BUCKLING RESISTING SPRING TENSIONER MECHANISM FOR A CONTINUOUS TRACK

(71) Applicant: Terra Drive Systems, Inc., Brookston, IN (US)

(72) Inventors: Daniel Skelton, West Lafayette, IN (US); Darren Erich Schultz, Rensselaer, IN (US)

(73) Assignee: Terra Drive Systems, Inc., Brookston, IN (US)

(21) Appl. No.: 19/211,808

(22) Filed: May 19, 2025

Related U.S. Application Data
(60) Provisional application No. 63/659,867, filed on Jun. 14, 2024.

(51) Int. Cl. B62D 55/30; B62D 55/10; B62D 55/14; B62D 55/24

(52) U.S. Cl. CPC B62D 55/305; B62D 55/10; B62D 55/14; B62D 55/244

(57) ABSTRACT

A continuous track can comprise a frame, a pivot arm pivotably secured to the frame, one or more idler wheels rotatably secured to the pivot arm, one or more rollers rotatably secured to the frame, an endless belt circumscribing and entrained around the rollers and the idler wheels, and a spring tensioner mechanism coupled between the pivot arm and the frame. The spring tensioner mechanism can comprise a U-shaped bracket pivotably secured to the pivot arm, a retaining rod secured to and extending from the U-shaped bracket, and a spring which is received over the retaining rod and is coupled between the U-shaped bracket and the frame. The retaining rod is adapted to support and prevent the spring from deflecting or buckling, and the U-shaped bracket is adapted to pivot in response to a spring force generated by the spring for automatically aligning the retaining rod coaxially with the spring.

### CROSS REFERENCE TO RELATED APPLICATION

This application claims priority under 35 U.S.C. 119 (e) of U.S. provisional patent application Ser. No. 63/659,867 filed on Jun. 14, 2024, entitled Automatically Aligning, Deflection and Buckling Resisting Spring Tensioner Mechanism for a Continuous Track, the disclosure of which is hereby incorporated herein by reference.

### BACKGROUND OF THE INVENTION

### 1. Field of the Invention

The present invention relates to continuous tracks and continuous track assemblies used on track laying or track-type vehicles such as agricultural trailers. More particularly, the present invention is directed to a automatically aligning, deflection and buckling resisting spring tensioner mechanism for maintaining tension on the endless belts/chains of continuous tracks.

### 2. Background

Continuous tracks, also known as “continuous track assemblies”, “tracked treads”, “caterpillar tracks”, and “tank tracks”, are often used in vehicles, and, in particular, agricultural vehicles such as, for example, carts, trailers, tractors, and harvester combines, to increase traction and reduce ground pressure and soil compaction. For example, agricultural trailers can include a pair of continuous tracks in place of traditional wheels to spread the weight of the trailer across a larger surface area and thereby reduce the pressure on the soil. Continuous tracks typically comprise a plurality of rollers rotatably secured to a frame and an endless belt supported by and entrained around the rollers.

In operation, tension is maintained on the endless belts to prevent them from slipping off the rollers. That is, as the continuous tracks traverse over bumps, divots, and otherwise rough or uneven terrain, the belts deflect and flex/bend which causes the belts to dislodge from or slip off of the rollers resulting in damage and wear and tear thereto. To prevent the belts from dislodging or slipping off the rollers, continuous tracks typically include a spring tensioner mechanism, also known as a “recoil” mechanism. Spring tensioner mechanisms typically comprise a spring coupled one or more of the rollers, commonly referred to as the “idler” rollers. The spring pushes/drives the idler wheels against endless belt, taking up any slack and placing the belt under tension. Deflecting or buckling of the spring, however, can cause the spring tensioner mechanism to fail, thereby releasing the tension on the endless belt and causing damage thereto.

Accordingly, there exists a need for a spring tensioning mechanism which resists deflecting or buckling of the springs thereof.

### SUMMARY OF THE INVENTION

In one form thereof, the present invention is directed to a spring tensioner mechanism for a continuous track. The continuous track can comprise a pivot arm pivotably secured to a frame, one or more idler wheels rotatably secured to the pivot arm, one or more rollers rotatably secured to the frame, and an endless belt circumscribing and entrained around the rollers and the idler wheels. The spring tensioner mechanism is adapted create tension in the endless belt by pivoting the pivot arm away from the frame.

The spring tensioner mechanism can comprise a U-shaped bracket pivotably secured to the pivot arm, a retaining rod secured to and extending from the U-shaped bracket, and a spring which is received over the retaining rod and is coupled between the U-shaped bracket and the frame. The retaining rod is adapted to support and prevent the spring from deflecting or buckling, and the U-shaped bracket is adapted to pivot in response to a spring force F1 generated by the spring for automatically aligning the retaining rod coaxially with the spring.

Preferably, the U-shaped bracket comprises a central bracket beam and a pair of bracket arms extending perpendicularly from the respective left and right edges of the central bracket beam. Preferably, the bracket arms are pivotably secured to the pivot arm, the retaining rod is secured to and extends from the central bracket beam, and the spring is received over the spring retaining rod and abuts the central bracket beam.

Preferably, U-shaped bracket pivots around a bracket pivot axis A1 defined extending perpendicularly through the bracket arms and the central bracket beam is offset from bracket pivot axis A1 such that that the U-shaped bracket acts like a swing for aligning the retaining rod coaxially with the spring.

Preferably, the retaining rod does not extend fully through the spring. Yet more preferably, the retaining rod is sized such that, when the spring is compressed between the U-shaped bracket and the frame, and the retaining rod does not abut the frame.

Preferably, the spring tensioner mechanism further comprises an adjustable pretensioner. The adjustable pretensioner can comprise a retaining tube secured to the frame and an adjustable ram. The retaining tube can comprise a spring retaining bore and the adjustable ram can comprise a piston sized to fit within and traverse through the spring retaining tube and a drive bolt which engages and selectively extends or retracts the piston through the central spring retaining bore. The spring can be received into the central spring retaining bore and can be sandwiched between the U-shaped bracket and the piston.

Preferably, the retaining rod is sized such that, when the spring is compressed between the U-shaped bracket and the piston, the retaining rod does not abut the piston.

Preferably, the retaining tube comprises one or more slots extending through the retaining tube transverse to the spring retaining bore whereby the position of the piston within the spring retaining bore is visible through the slots.

Preferably, the spring is a helical compression spring comprising an interior edge which circumscribes a cylindrical passage therethrough. The retaining rod can be received into the passage and slidingly engages the spring interior edge for supporting and preventing the spring from deflecting or buckling as the spring is compressed. Yet more preferably, the spring comprises a pair of concentric helical compression springs.

In another form thereof, the present invention is directed to a continuous track for supporting and providing traction for a vehicle. The continuous track can comprise a pivot arm pivotably secured to a frame, one or more idler wheels rotatably secured to the pivot arm, one or more rollers rotatably secured to the frame, an endless belt circumscribing and entrained around the rollers and the idler wheels, and a spring tensioner mechanism adapted create tension in the endless belt by pivoting the pivot arm away from the frame.

The spring tensioner mechanism can comprise a U-shaped bracket pivotably secured to the pivot arm, a retaining rod secured to and extending from the U-shaped bracket, and a spring which is received over the retaining rod and is coupled between the U-shaped bracket and the frame. The retaining rod can be adapted to support and prevent the spring from deflecting or buckling, and the U-shaped bracket can be adapted to pivot in response to a spring force F1 generated by the spring for automatically aligning the retaining rod coaxially with the spring.

Preferably, the frame comprises a pair of horizontally spaced apart wings extending from a leading end of the frame. The pivot arm can be pivotably secured between the wings, and the U-shaped bracket can be secured to the pivot arm such that the retaining rod and the spring are centered horizontally between the wings.

Preferably, the pivot arm comprises an upper pivot arm end which is pivotably secured to the frame, a lower pivot arm end whereat the U-shaped bracket is pivotably secured, and a spring receiving channel formed in the lower pivot arm end. The retaining rod and the spring can extend through the spring receiving channel.

Preferably, the spring can be selectively compressed for removing and replacing the endless belt by pivoting the pivot arm towards the frame. The retaining rod is preferably sized such as the spring is selectively compressed, the retaining rod does not abut the frame.

Preferably, the continuous track further comprises an adjustable pretensioner. The adjustable pretensioner can comprise a retaining tube secured to the frame and an adjustable ram. The retaining tube can comprise a spring retaining bore, and the adjustable ram can comprise a piston sized to fit within and traverse through the spring retaining tube and a drive bolt which engages and selectively extends or retracts the piston through the central spring retaining bore. The spring can be received into the central spring retaining bore and can be sandwiched between the U-shaped bracket and the piston.

Yet more preferably, the spring can be selectively compressed for removing and replacing the endless belt by pivoting the pivot arm towards the frame, and the retaining rod can sized such as the spring is selectively compressed, the retaining rod does not abut the piston.

### BRIEF DESCRIPTION OF THE DRAWINGS

The above-mentioned and other features of this invention and the manner of attaining them will become more apparent, and the invention itself will be better understood by reference to the following description of the embodiments of the invention, taken in conjunction with the accompanying drawings, wherein:

FIG. 1 is a perspective view of a trailer having a pair of continuous tracks;

FIG. 2 is a side elevation view of a continuous track;

FIG. 3 is a magnified detail view of Circled Detail A shown in FIG. 2 wherein an idler wheel has been removed for greater clarity;

FIG. 4 is a top plan view of the continuous track shown in FIG. 2 wherein a portion of the endless belt has been removed to show the frame, idler wheels, pivot arm, and spring tensioner mechanism;

FIG. 5 is a side elevation view similar to FIG. 3 wherein the endless belt is shown in hidden lines;

FIG. 6 is an exploded perspective view of the frame, pivot arm, and spring tensioner mechanism shown in FIGS. 3 and 5;

FIG. 7 is an exploded side view of the frame, pivot arm, and spring tensioner mechanism shown in FIGS. 3, 5, and 6;

FIG. 8 is a side elevation view of the frame, pivot arm, and spring tensioner mechanism shown in FIGS. 3 and 5;

FIG. 9 is a side elevation view of the frame, pivot arm, and spring tensioner mechanism shown in FIG. 8 wherein the pivot arm is pivoted towards the frame and the spring of the spring tensioner mechanism is compressed;

FIG. 10 is a cross-section view of the continuous track taken along the line 10-10 shown in FIG. 4

FIG. 11 is a magnified detail view of Circled Detail B shown in FIG. 10;

FIG. 12 is a magnified detail view of Circled Detail B like FIG. 11, wherein the pivot arm and the U-shaped bracket are pivoted towards the frame and the spring has compressed and bent/buckled;

FIG. 13 is an exploded perspective view of the frame, pivot arm, and another embodiment of the spring tensioner mechanism having a pair of concentric springs;

FIG. 14 is a cross-section view like FIG. 10 showing the embodiment of the spring tensioner mechanism having a pair of concentric springs; and

FIG. 15 is a magnified detail view of Circled Detail C shown in FIG. 14.

Corresponding reference characters indicate corresponding parts throughout several views. Although the exemplification set out herein illustrates certain embodiments of the invention, the embodiments disclosed below are not intended to be exhaustive or to be construed as limiting the scope of the invention to the precise form disclosed.

### DETAILED DESCRIPTION OF THE PREFERRED EMBODIMENTS

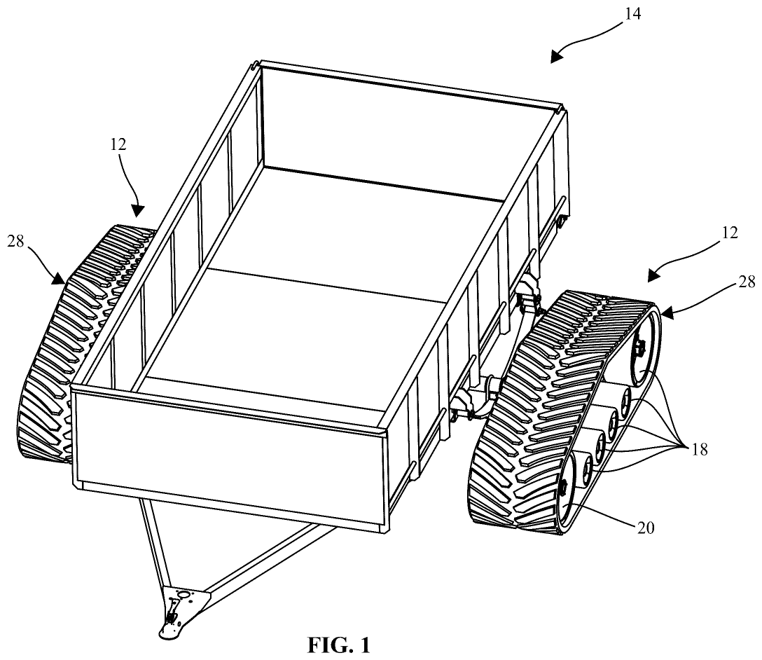

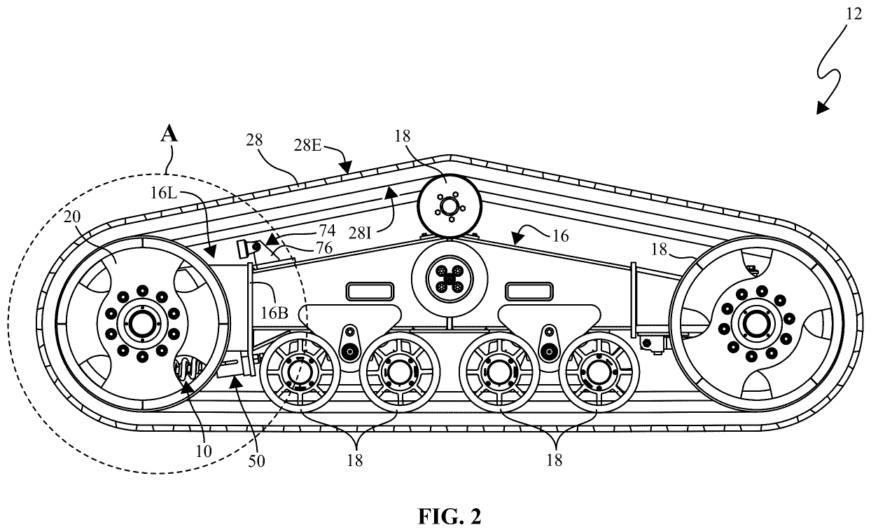

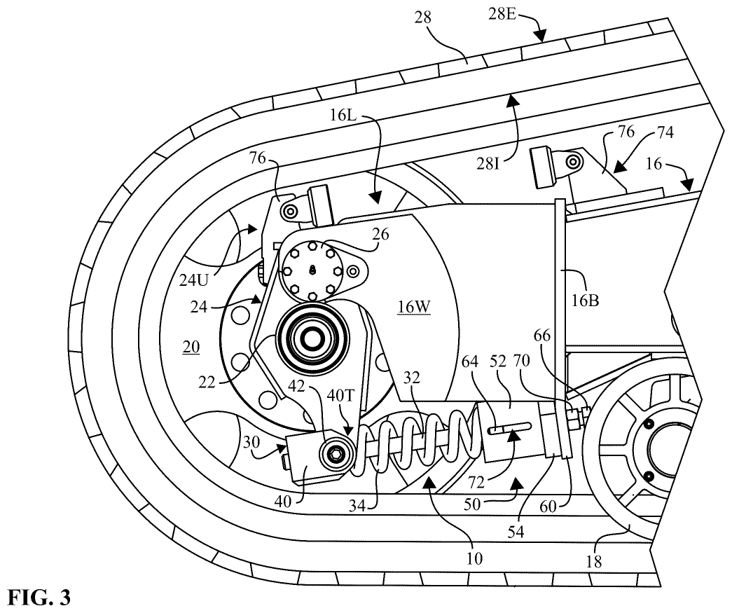

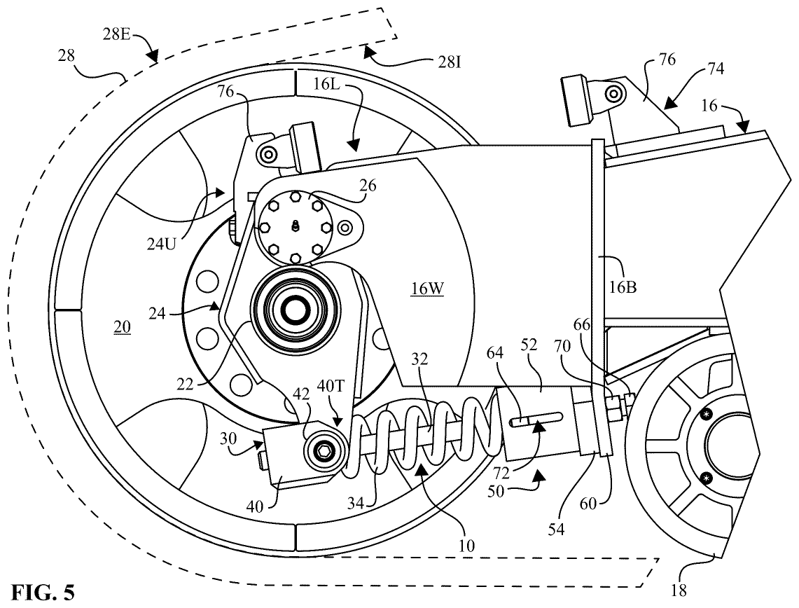

Referring initially to FIGS. 1-7, a spring tensioner mechanism constructed in accordance with the principles of the present invention is generally designated by the numeral 10 and is installed on a continuous track 12. Continuous tracks 12, also known as “continuous track assemblies”, “tracked treads”, “caterpillar tracks”, or “tank tracks,” are used on vehicles such as agricultural trailers to increase traction and/or to decrease ground pressure and soil compaction. For example, an agricultural trailer 14 can comprise a pair of continuous tracks 12 in place of traditional wheels and tires (not shown) to spread the weight of the trailer 14 across a larger surface area, thereby reducing ground pressure and soil compaction.

The continuous tracks 12 comprise a frame 16, a plurality of rollers 18 rotatably secured to the frame 16, a pair of idler wheels 20 rotatably secured to a pivot arm 24 which is pivotably secured to the frame 16, and an endless belt 28 supported by and entrained around the rollers 18 and the idler wheels 20. More particularly, the idler wheels 20 are rotatably mounted on an idler wheel axle 22 which is secured to the pivot arm 24, and the pivot arm 24 is pivotably mounted on a pivot arm axle 26 which is secured to a leading end 16L of the frame 16. The endless belt 28 is, preferably, a flexible elastomeric belt/track adapted to surround/circumscribe the rollers 18 and the idler wheels 20 and comprises an interior roller engaging surface 28I which engages the rollers 18 and the idler wheels 20 and an exterior ground engaging traction surface 28E which engages the ground and provides traction for the trailer 14.

The spring tensioner mechanism 10 is coupled between the pivot arm 24 and the frame 16 and is adapted to push the idler wheels 20 against the belt interior roller engaging surface 28I for tensioning the belt 28. The spring tensioner mechanism 10 comprises a U-shaped bracket 30, a retaining rod 32, and a spring 34. The U-shaped bracket 30 is pivotably secured to the pivot arm 24. The retaining rod 32 is secured to the U-shaped bracket 30 and extends therefrom towards the frame 16. The spring 34 is received over the retaining rod 32 and is sandwiched between the U-shaped bracket 30 and the frame 16. The spring tensioner mechanism 10 and the pivot arm 24 are preferably centered between the idler wheels 20 and are aligned longitudinally with the frame 16.

In operation, the spring 34 is compressed between the U-shaped bracket 30 and the frame 16 and exerts a spring force F1 on the pivot arm 24 through the U-shaped bracket 30. The spring force F1 pivots/drives the pivot arm 24 outwardly away from the frame leading end 16L and pushes the idler wheels 20 against the belt interior roller engaging surface 28I. As mentioned above, the endless belt 28 surrounds/circumscribes the rollers 18 and the idler wheels 20, and so, when the idler wheels 20 are pushed against interior roller engaging surface 28I, the endless belt 28 is pulled taut against the other rollers 18, thereby placing the belt 28 under tension. Further, when the continuous tracks 12 traverse over an obstacle, the spring 34 is adapted to compress as tension on the endless belt 28 increases, thereby allowing the endless belt 28 to deflect/flex/bend over the obstacle.

Preferably, the pivot arm 24 comprises an upper end 24U which is pivotably secured to the pivot arm axle 22 and a lower end 24L which is pivotably secured to the U-shaped bracket 30. Additionally, the idler wheel axle 22 is preferably secured to the pivot arm 24 vertically between the upper end 24U and the lower end 24L. In this regard, the pivot arm 24 is adapted to act like a lever such that the tension in the endless belt 28 is greater than the spring force F1, thereby allowing smaller springs to be used while maintaining sufficient tension on the endless belts 28. Of course, the spring 34 can be selected based on the tension required for different types or sizes of endless belts 28 and/or different types or sizes of continuous tracks 12.

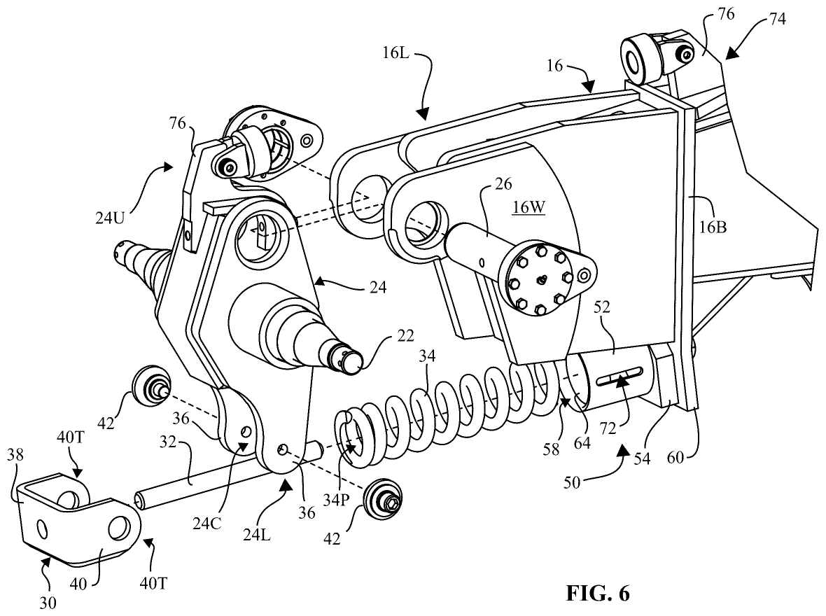

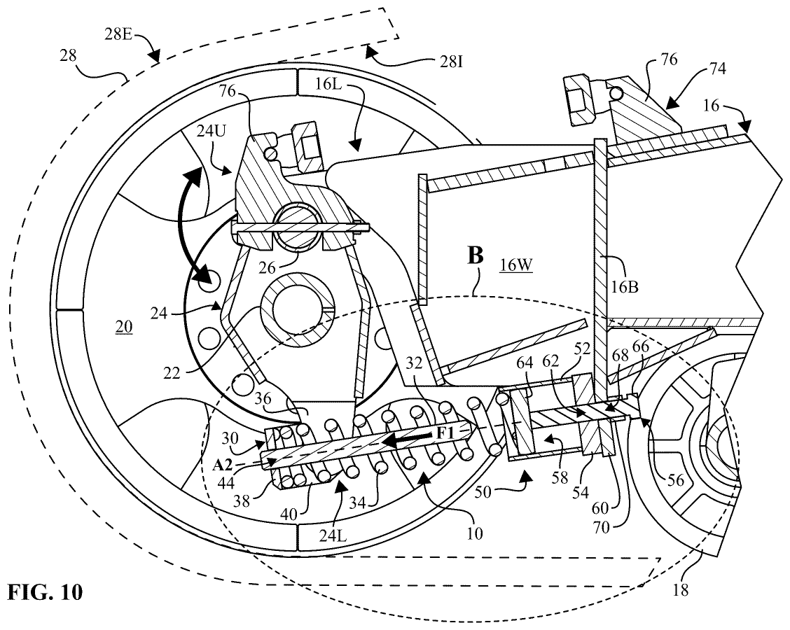

Referring now to FIGS. 6-12, as mentioned above, the spring tensioner mechanism 10 comprises a U-shaped bracket 30, a retaining rod 32, and a spring 34. The U-shaped bracket 30 comprises a central bracket beam 38 and a pair of bracket arms 40 which are spaced horizontally apart from each other and extend perpendicularly from the respective right and left edges of the central bracket beam 38 for thereby forming a U-shape. The bracket arms 40 are pivotably secured one on each side of the pivot arm 24 by a pair of bracket axles 42 such that the U-shaped bracket 30 is pivotable about a bracket pivot axis A1 extending through the bracket axles 42.

The retaining rod 32 is a rigid, and preferably cylindrical, rod which is secured to the central bracket beam 38 and extends perpendicularly therefrom towards the frame 16. Preferably, the central bracket beam 38 includes a retaining rod receiving bore 44 and the retaining rod 32 is secured to the U-shaped bracket 30 by press-fitting the retaining rod 32 into the retaining rod receiving bore 44. The retaining rod 32 can also be secured to the central bracket beam 38 by other securing means, such as, for example, welding, sintering, adhering, or fastening.

The spring 34 is received over and surrounds the retaining rod 32 with one end thereof abutting the central bracket beam 38 and the other end secured to the frame 16. More particularly, the spring 34 is preferably a helical compression spring comprising an interior edge 34E which circumscribes a cylindrical passage 34P extending longitudinally through the center of the spring 34. The retaining rod 32 is received into the cylindrical passage 34P and is aligned coaxially with a longitudinal axis A2 of the spring 34/cylindrical passage 34P. As the spring 34 compresses, the retaining rod 32 “retains” the spring 34 by supporting and preventing spring 34 from slipping off of the U-shaped bracket 30.

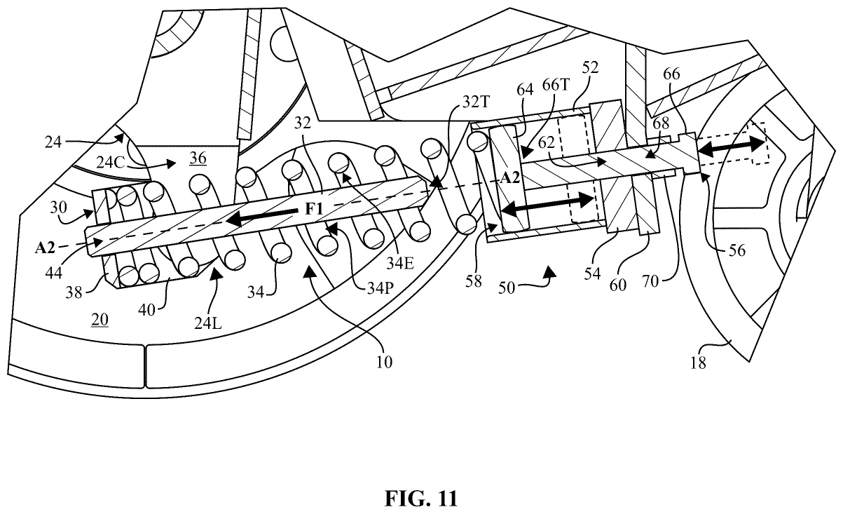

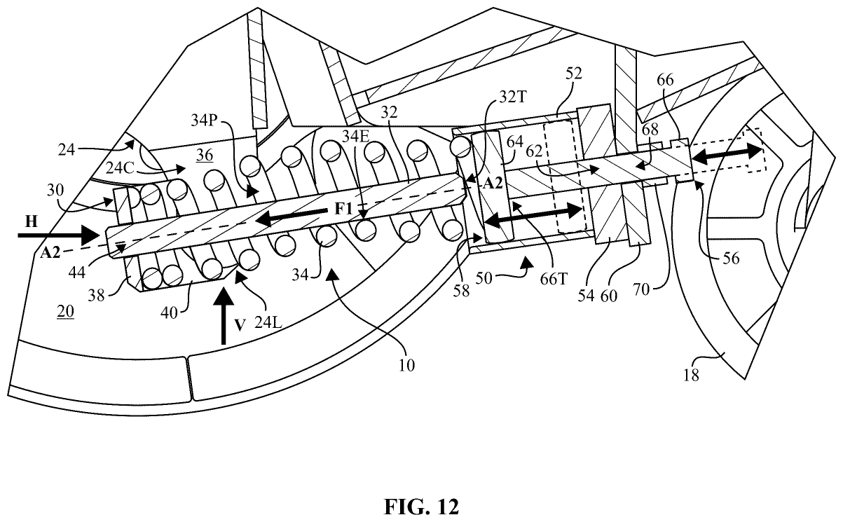

The retaining rod 32 also supports and prevents the spring 34 from deflecting or buckling as the spring 34 compresses. That is, compression springs, and particularly helical compression springs having a longitudinal length that is substantially greater than their width, tend to deflect and/or buckle along their longitudinal length when they are compressed. For example, an unsupported helical compression spring will typically deflect/bend and/or buckle in a direction transverse to the longitudinal length of the spring, typically, near the midpoint along the length of the spring. In this regard, as best seen in FIGS. 11 and 12, the retaining rod 32 preferably extends along a majority of the longitudinal length of the spring 34. Accordingly, as the spring 34 compresses begins to deflect/bend and/or buckle, the spring interior edges 34E engage the rigid retaining rod 32, whereby the spring 34 is maintained in alignment along the spring longitudinal axis A2 and is thereby preventing deflecting/bending and/or buckling thereof.

Of course, as the spring 34 compresses and the pivot arm 24 and U-shaped bracket 30 pivot towards the frame 16, the retaining rod 32 will traverse towards the frame 16 and, as will be discussed in greater detail hereinbelow, the piston 64. Accordingly, the retaining rod 32 is preferably sized such that there is sufficient room between the terminal end 32T of the retaining rod 32 and the frame 16/piston 64 to allow the pivot arm 24 to pivot towards the frame 16 without the retaining rod 32 hitting against the frame 16/piston 64.

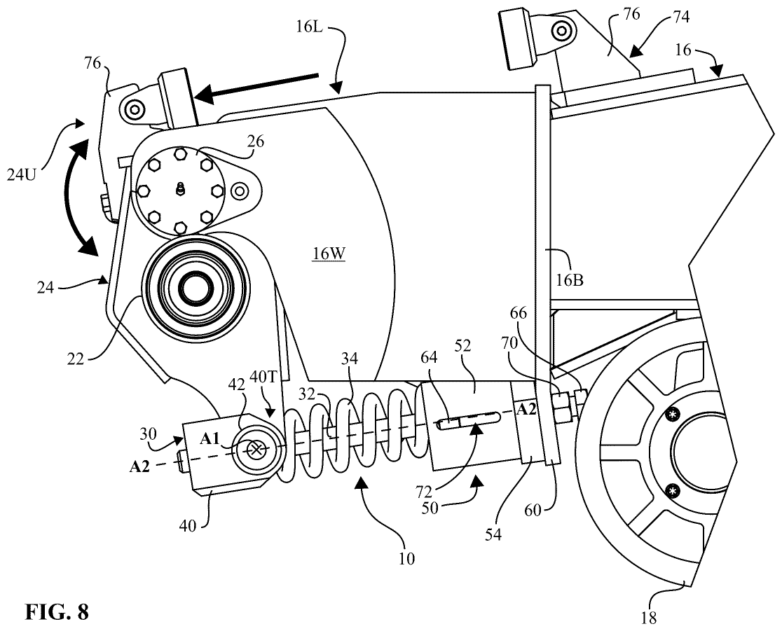

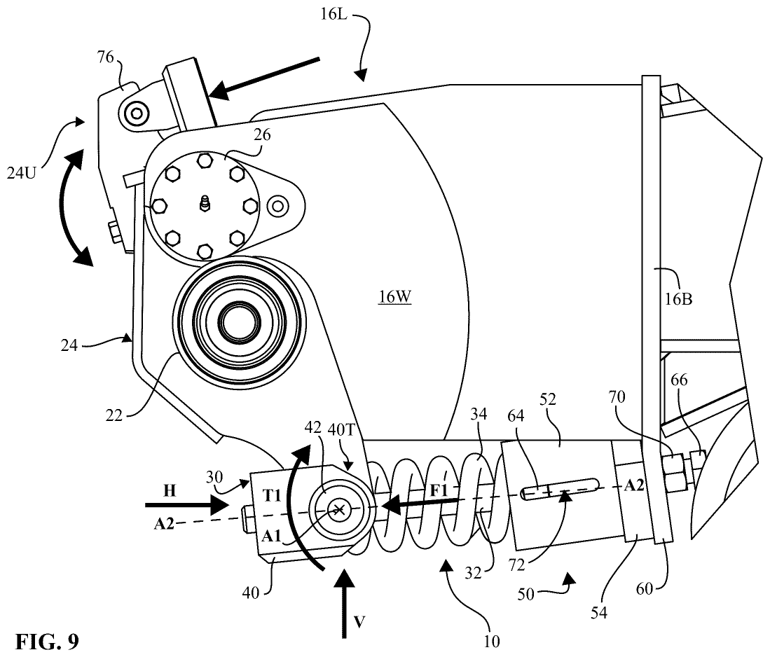

As best seen in FIGS. 8 and 9, the bracket axles 42 are preferably secured to the terminal ends 40T of the bracket arms 40 and the retaining rod 32 extends perpendicularly from the central bracket beam 38 and intersects with the bracket pivot axis A1. By securing the bracket axles 42 to the bracket arm terminal ends 40T, the central bracket beam 38 is offset from the bracket pivot axis A1 and acts like a “swing” whereby the spring force F1 exerted on the central bracket beam 38 causes the U-shaped bracket 30 and the retaining rod 32 to pivot and automatically align with the spring 34.

More particularly, as the pivot arm 24 pivots towards the frame 16 (FIG. 9), the bracket pivot axis A1 moves horizontally towards the frame 16 and vertically upwardly. As the bracket pivot axis A1 moves vertically, the spring force F1, which is exerted along the central longitudinal axis A2 of the spring 34, creates a pivot torque Tl about the bracket pivot axis A1 equal to the product of the spring force F1 multiplied by the distance between the central longitudinal axis A2 and the bracket pivot axis A1. This pivot torque Tl causes the U-shaped bracket 30 to automatically pivot until the central longitudinal axis A2 intersects with the bracket pivot axis A1; where the distance between the central longitudinal axis A2 and the bracket pivot axis A1 is zero. When the central longitudinal axis A2 is intersecting with the bracket pivot axis A1, the retaining rod 32, which also intersects with the bracket pivot axis A1, is aligned coaxially with the spring central longitudinal axis A2. Thus, the spring force F1 causes the U-shaped bracket 30 to “swing” and thereby automatically align the retaining rod 32 coaxially with the spring 34.

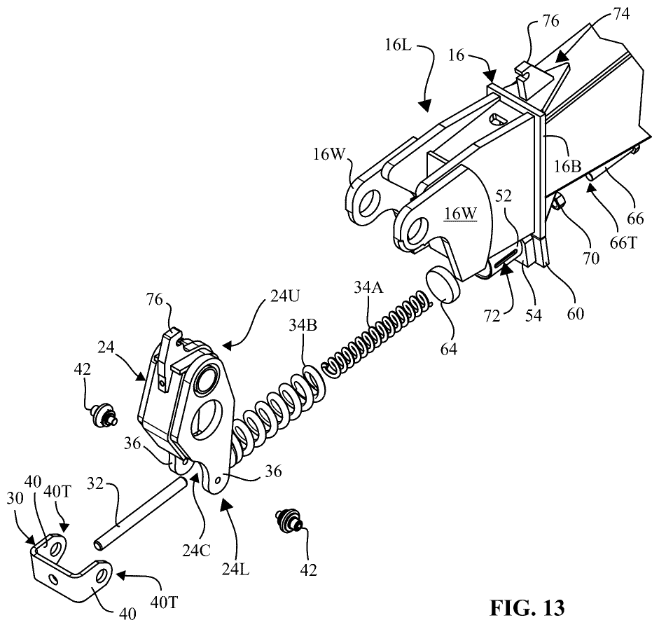

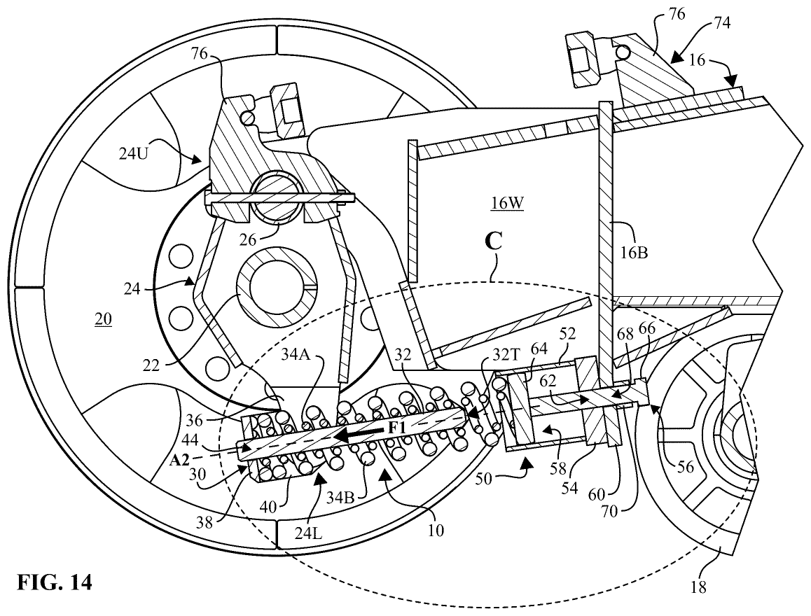

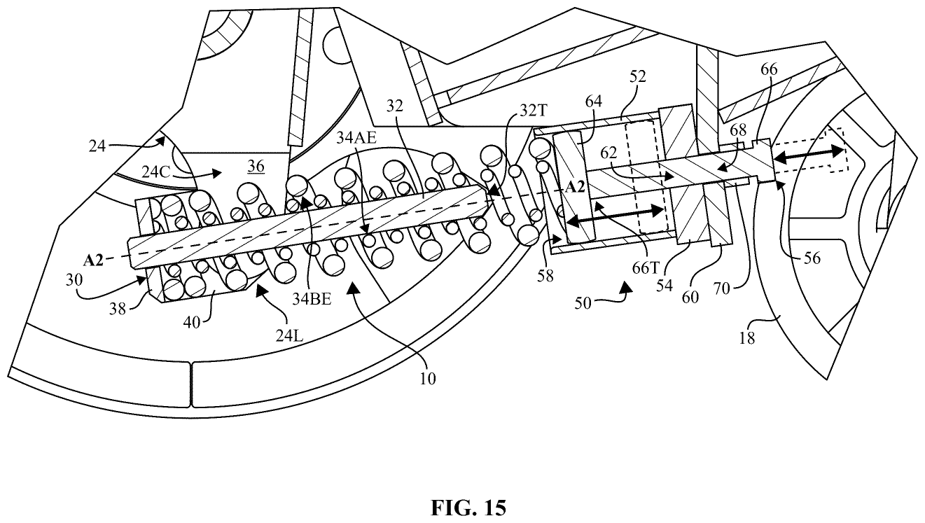

Preferably, the spring 34 preferably comprises a pair of concentric inner and outer springs 34A, 34B (FIGS. 13-15). The inner spring 34A is slidingly received over and surrounds the retaining rod 32 and the outer spring 34B is slidingly received over and surrounds the inner spring 34A. As the springs 34A, 34B are compressed, the interior edge 34AE of the inner coil spring 34A slides along the retaining rod 32 which supports and prevents the inner spring 34A from deflecting or buckling. Similarly, the interior edge 34BE of the outer spring 34B slides along the inner spring 34A, whereby the inner spring 34A and the retaining rod 32 support and prevent the outer spring 34B from deflecting or buckling.

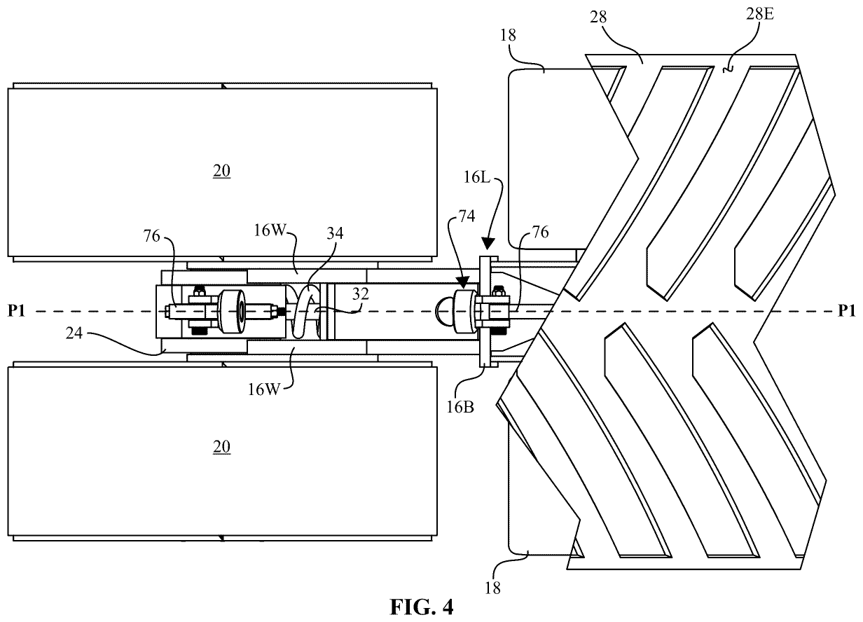

Returning to FIGS. 4 and 6, as mentioned above, the spring tensioner mechanism 10 and the pivot arm 24 are preferably centered between the idler wheels 20 and are aligned longitudinally with the frame 16. More particularly, the frame leading end 16L comprises a pair of wings 16W which extend perpendicularly from a frame base 16B. The wings 16W are horizontally apart from each other and the pivot arm axle 26 extends perpendicularly therebetween. The pivot arm 24 is centered between the wings 16W and the upper end 24U of the pivot arm 24 is rotatably secured to the pivot arm axle 26. The idler wheels 20 are rotatably mounted on the idler wheel axle 22 one on each side of the pivot arm 24.

A spring receiving channel 24C is formed in the lower end 24L of the pivot arm 24, and a pair of horizontally spaced apart bracket mounting fins 36 are defined one on each side of the spring receiving channel 24C. The U-shaped bracket 30 is pivotably secured to the pivot arm lower end 24L with a bracket arm 40 pivotably secured to each of the fins 36 by a bracket axle 42. Preferably, the bracket arms 40 are secured to the exterior side surfaces 36ES of the bracket mounting fins 36 such that the bracket arms 40 are located outside of the spring receiving channel 24C.

The retaining rod 32 is secured to the U-shaped bracket central bracket beam 38 and extends through the spring receiving channel 24C. The spring 34 is received over and surrounds the retaining rod 32 and also extends through the spring receiving channel 24C. Preferably, the retaining rod 32 and the spring 34 are centered horizontally between the bracket mounting fins 36 and are also centered horizontally between the wings 16W.

As should now be appreciated, the pivot arm 24, the idler wheels 20, the U-shaped bracket 30, the retaining rod 32, and the spring 34 are each centered between the frame wings 16W and are preferably aligned along a longitudinal vertical plane P1. Further, the idler wheel, pivot arm, and bracket axles 22, 26, 42 are preferably perpendicular to the longitudinal vertical plane P1 such that the pivot arm 24, the idler wheels 20, the U-shaped bracket 30, and the retaining rod 32 remain aligned with the longitudinal vertical plane P1, and each other, as they pivot around the axles 22, 26, 42, respectively. By configuring the components to remain aligned with each other, the spring force F1 is transferred evenly to the endless belt 28 through the idler wheels 20, thereby minimizing any undesirable torques or bending forces which could bend, damage, or wear out the endless belt 28, the idler wheels 20, the pivot arm 24, or the spring tensioner mechanism 10.

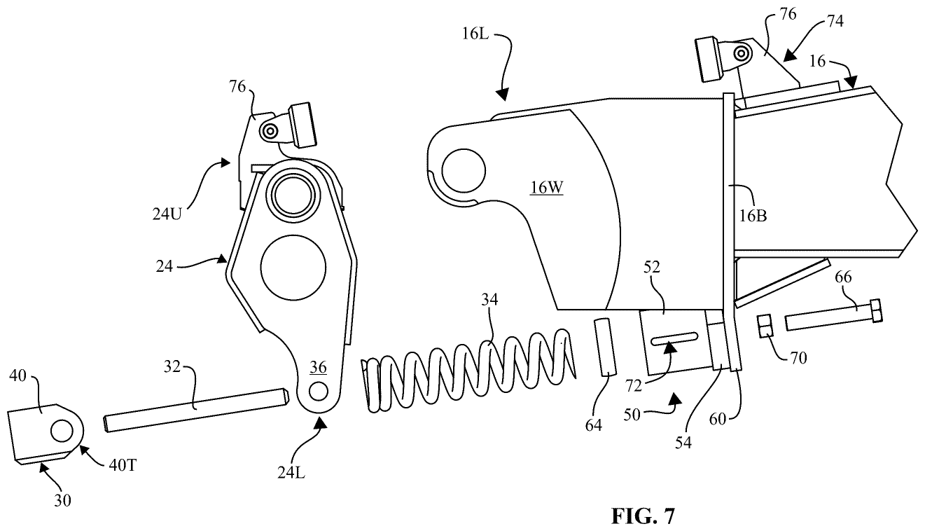

Turning to FIGS. 7, 10-12, 14, and 15, the spring tensioner mechanism 10 preferably includes an adjustable pretensioner 50 which can be used to selectively increase or decrease the tension on the endless belt 28. The pretensioner 50 comprises a retaining tube 52, a support pad 54, and an adjustment ram 56. The retaining tube 52 is secured to the support pad 54 and includes a central spring retaining bore 58. The spring 34 is received into the central spring retaining bore 58 for preventing the spring 34 from sliding or deflecting away from the frame 16. The support pad 54 is secured to a pretensioner flange 60 which extends downwardly from the frame 16. The support pad 54 includes a threaded bore 62 which extends through the support pad 54 and opens into the central spring retaining bore 58. The pretensioner flange 60 includes a flange clearance bore 68 which extends through the flange 60 and opens into the threaded bore 62.

The adjustment ram 56 includes a piston 64 sized to fit within and traverse through the central spring retaining bore 58 and a drive bolt 66 adapted to extend through the flange clearance bore 68 and threadingly engage the support pad threaded bore 62. In operation, the spring 34 is sandwiched between the piston 64 and the central bracket beam 38 and the piston 64 is sandwiched between the spring 34 and a terminal end 66T of the drive bolt 66. By rotatingly driving the drive bolt 66, which extends or retracts the drive bolt 66 through the threaded bore 62, the piston 64 can be selectively extended or retracted through the central spring retaining bore 58. As the piston 64 is extended or retracted through the central spring retaining bore 58, the spring 34 is compressed or decompressed for thereby increasing or decreasing spring force F1 and, therefore, the tension on the endless belt 28.

Preferably, the adjustment ram also includes a lock nut 70 which is threaded onto the drive bolt 66 is adapted to rotatingly tightened against the pretensioner flange 60 for “locking” the adjustment ram 56 in position once the endless belt 28 is under the desired level of tension. In operation, the adjustment ram 56 is used by loosening the lock nut 70; adjusting the tension on the endless belt 28 by rotatingly driving the drive bolt 66 and thereby extending or retracting the piston 64 through the spring receiving bore 58; and tightening the lock nut 70 against the pretensioner flange 60 for locking the adjustment ram 56 in position once the endless belt 28 is under the desired level of tension.

Preferably, the retaining tube 52 can also include side slots 72 extending through the retaining tube 52 transverse to the central spring retaining bore 58 whereby the piston 64 is visible through the side slots 72 such that an operator can visually check the position of the piston 64 and thereby gauge the relative level of tension on the endless belt 28.

Preferably, the continuous track 12 further includes a track replacement mechanism 74. The track replacement mechanism 74 can comprise fingers 76 extending upwardly from the pivot arm upper end 24U and the frame 16. In operation, a linear actuator, such as, for example, a hydraulic ram (not shown), can be coupled between the fingers 76 and extended, whereby the pivot arm finger 76 is driven away from the frame finger 76. As the pivot arm finger 76 is driven away from the frame finger 76, the pivot arm lower end 24L pivots towards frame 16 (FIG. 9), thereby pulling the idler wheels 20 away from the endless belt 28 and releasing tension therefrom. Once the endless belt 28 is sufficiently loose, it can be removed and a new endless belt 28 can be installed. After the new belt 28 has been installed, the hydraulic ram 78 can be retracted, allowing the spring 34 to extend and pivot/drive the pivot arm 24 away from the frame 16, thereby driving the idler wheels 20 against the interior roller engaging surface 28I and placing the new belt 28 under tension.

Returning to FIGS. 11 and 12, as mentioned above, the retaining rod 32 is preferably sized such that there is sufficient room between the terminal end 32T of the retaining rod 32 and piston 64 to allow the pivot arm 24 to pivot towards the frame 16 without the retaining rod 32 hitting against the frame 16/piston 64. Yet more preferably, the retaining rod 32 is sized such that the endless belt 28 can be removed and replaced without requiring any adjustments to the adjustable pretensioner 50. That is, the retaining rod 32 is sized such that the pivot arm 24 can pivot towards the frame 16 far enough for the endless belt 28 to be removed and replaced without the retaining rod 32 contacting the piston 64 (FIG. 12). Of course, the size of the retaining rod 32 can be selected based on the distance the pivot arm 24 must pivot towards the frame 16 for different types or sizes of endless belts 28 to be removed and replaced.

Preferably, except as otherwise set forth herein, the components of the spring tensioner mechanism 10 are formed from a rigid, high-strength material such as, for example, steel, aluminum, or other high-strength metals. Preferably, except as otherwise set forth herein, the components of the spring tensioner mechanism 10 are formed by casting, molding, machining, or otherwise shaping or forming from a unitary material.

While this invention has been described as having an exemplary design, the present invention may be further modified within the spirit and scope of this disclosure. This application is therefore intended to cover any variations, uses, or adaptations of the invention using its general principles. For example, although the spring tensioner mechanism 10 is shown as being installed on a continuous track 12 having an endless belt 28, it should be understood that the spring tensioner mechanism 10 can also be installed on a continuous track 12 comprising an endless chain (not shown).

What is claimed is:

1. A spring tensioner mechanism for a continuous track comprising:
a pivot arm pivotably secured to a frame;
one or more idler wheels rotatably secured to the pivot arm;
one or more rollers rotatably secured to the frame; and
an endless belt circumscribing and entrained around the rollers and the idler wheels;
wherein the spring tensioner mechanism is adapted create tension in the endless belt by pivoting the pivot arm away from the frame, the spring tensioner mechanism comprising:
a U-shaped bracket pivotably secured to the pivot arm;
a retaining rod secured to and extending from the U-shaped bracket; and
a spring which is received over the retaining rod and is coupled between the U-shaped bracket and the frame;
wherein the retaining rod supports and prevents the spring from deflecting or buckling; and
wherein the U-shaped bracket pivots in response to a spring force F1 generated by the spring for automatically aligning the retaining rod coaxially with the spring.

2. The spring tensioner mechanism of claim 1, wherein the U-shaped bracket comprises a central bracket beam and a pair of bracket arms extending perpendicularly from the respective left and right edges of the central bracket beam, and wherein the bracket arms are pivotably secured to the pivot arm.

3. The spring tensioner mechanism of claim 2, wherein the retaining rod is secured to and extends from the central bracket beam and the spring is received over the spring retaining rod and abuts the central bracket beam.

4. The spring tensioner mechanism of claim 2, wherein the U-shaped bracket pivots around a bracket pivot axis A1 defined extending perpendicularly through the bracket arms, and wherein the central bracket beam is offset from bracket pivot axis A1 such that that the U-shaped bracket acts like a swing for aligning the retaining rod coaxially with the spring.

5. The spring tensioner mechanism of claim 1, wherein the retaining rod does not extend fully through the spring.

6. The spring tensioner mechanism of claim 1, wherein the spring is compressed between the U-shaped bracket and the frame, and wherein the retaining rod is sized such that as the spring is compressed, the retaining rod does not abut the frame.

7. The spring tensioner mechanism of claim 1 further comprising an adjustable pretensioner, the adjustable pretensioner comprising:
a retaining tube secured to the frame, the retaining tube having a central spring retaining bore; and
an adjustable ram comprising:
a piston sized to fit within and traverse through the spring retaining tube; and
a drive bolt which engages and selectively extends or retracts the piston through the central spring retaining bore;
wherein the spring is received into the central spring retaining bore and is sandwiched between the U-shaped bracket and the piston.

8. The spring tensioner mechanism of claim 7, wherein the spring is compressed between the U-shaped bracket and the piston, and wherein the retaining rod is sized such that as the spring is compressed, the retaining rod does not abut the piston.

9. The spring tensioner mechanism of claim 7, wherein the retaining tube comprises one or more slots extending through the retaining tube transverse to the spring retaining bore whereby the position of the piston within the spring retaining bore is visible through the slots.

10. The spring tensioner mechanism of claim 1, wherein the spring is a helical compression spring comprising an interior edge which circumscribes a cylindrical passage therethrough, and wherein the retaining rod is received into the passage and slidingly engages the spring interior edge for supporting and preventing the spring from deflecting or buckling as the spring is compressed.

11. The spring tensioner mechanism of claim 1, wherein the spring comprises a pair of concentric helical compression springs.

12. A continuous track for supporting and providing traction for a vehicle, the continuous track comprising:
a pivot arm pivotably secured to a frame;
one or more idler wheels rotatably secured to the pivot arm;
one or more rollers rotatably secured to the frame;
an endless belt circumscribing and entrained around the rollers and the idler wheels; and
a spring tensioner mechanism adapted create tension in the endless belt by pivoting the pivot arm away from the frame, the spring tensioner mechanism comprising:
a U-shaped bracket pivotably secured to the pivot arm;
a retaining rod secured to and extending from the U-shaped bracket; and
a spring which is received over the retaining rod and is coupled between the U-shaped bracket and the frame;
wherein the retaining rod supports and prevents the spring from deflecting or buckling; and
wherein the U-shaped bracket pivots in response to a spring force F1 generated by the spring for automatically aligning the retaining rod coaxially with the spring.

13. The continuous track of claim 12, wherein the frame comprises a pair of horizontally spaced apart wings extending from a leading end of the frame and the pivot arm is pivotably secured between the wings, and wherein the U-shaped bracket is secured to the pivot arm such that the retaining rod and the spring are centered horizontally between the wings.

14. The continuous track of claim 12, wherein the pivot arm comprises an upper pivot arm end which is pivotably secured to the frame, a lower pivot arm end whereat the U-shaped bracket is pivotably secured, and a spring receiving channel formed in the lower pivot arm end, and wherein the retaining rod and the spring extend through the spring receiving channel.

15. The continuous track of claim 12, wherein the spring can be selectively compressed for removing and replacing the endless belt by pivoting the pivot arm towards the frame, and wherein the retaining rod is sized such as the spring is selectively compressed, the retaining rod does not abut the frame.

16. The continuous track of claim 12 further comprising an adjustable pretensioner, the adjustable pretensioner comprising:
a retaining tube secured to the frame, the retaining tube having a central spring retaining bore; and
an adjustable ram comprising:
a piston sized to fit within and traverse through the spring retaining tube; and
a drive bolt which engages and selectively extends or retracts the piston through the central spring retaining bore;
wherein the spring is received into the central spring retaining bore and is sandwiched between the U-shaped bracket and the piston.

17. The spring tensioner mechanism of claim 16, wherein the spring can be selectively compressed for removing and replacing the endless belt by pivoting the pivot arm towards the frame, and wherein the retaining rod is sized such as the spring is selectively compressed, the retaining rod does not abut the piston.
